(19) United States
(12) Patent Application Publication
(10) Pub. No.: US 2012/0212000 A1
(43) Pub. Date: Aug. 23, 2012

(54) Trailer lock

(75) Inventor: Su Wen Chun, Hemei Township (TW)

(73) Assignee: HANDYWAY CO., LTD.

(21) Appl. No.: 12/929,854

(22) Filed: Feb. 22, 2011

(51) Int. Cl. E05B 65/52

(52) U.S. Cl. 292/164

(57) ABSTRACT

An improved trailer lock includes a lock body and a bolt. The lock body includes a housing, a bolt holder, a bushing, a spring, a core and a press dock. The bushing has a latch plate at one side. The latch plate has a bolt wedge trough at one side to form an upper anchor portion and a lower anchor portion at two sides thereof to latch two sides of a latch groove of the bolt during locking to form double sides latching. Thus the trailer lock has a greater locking strength and capability to withstand destruction to prevent damage of the lock body by external forces.

### BACKGROUND OF THE INVENTION

1. Field of the Invention

The present invention relates to an improved trailer lock and particularly to a trailer lock including a reinforced lock body to withstand destruction and provide enhanced locking to prevent damage by external forces.

2. Description of the Prior Art

A conventional trailer lock 2 contained a locking bolt (referring to FIG. 1) mainly includes a bolt 21 and a locking head 22 to form secure locking through coupling bores 121 and 111 of a vehicle coupler 12 and a trailer hitch 11 to couple a vehicle and a trailer together and also provide theft deterrent function. The bolt 21 and locking head 22 form a latch structure which generally includes at least one steel ball (or cylindrical strut) 221 latched through one side or two sides in a latch groove 211 formed on the bolt 21. While the aforesaid structure can provide locking and theft-deterrent effects, it does not have adequate strength to withstand destruction. This is mainly caused by the profile of the steel ball (or cylindrical strut) 221 moving circularly when the core is turned during locking to be pushed into the latch groove 211 to form latching. To meet such an end the profile of the lock has to be made streamline in spherical or circular. As a result its strength to resist external forces or tensile forces is limited. The lock body is easily sledged open or damaged under the external forces.

### SUMMARY OF THE INVENTION

In view of the aforesaid shortcomings of the conventional trailer lock the primary object of the present invention is to provide an improved trailer lock with a reinforced lock body to provide enhanced locking and destruction withstanding capability to prevent damage by external forces.

To achieve the foregoing object the invention includes a lock body and a bolt. The lock body includes at least a housing, a bolt holder, a bushing, a spring, a core and a press dock.

The housing has a first chamber at one side and a second chamber at another side perpendicular to the first chamber and communicating therewith, a first pin hole and a second pin hole on the case of the housing to receive respectively insertion of a first pin and a second pin.

The bolt holder is held in the first and second chambers, and has a bolt insertion hole at one side and a cavity at another side, a stepped opening at the circumference of the cavity, and a first insertion slot and a second insertion slot transversely formed on an outer side of the stepped opening in a parallel manner to be wedged in by a first side section and a second side section of a U-shaped elastic element.

The bushing has a barrel with one side extended outwards to form an outer flange. The barrel also has a core holding chamber and a wedge member and a slot on the periphery. The wedge member is latchable with a corresponding wedge notch at one end of a latch plate. The latch plate has another end formed a wedge trough for the bolt that has two sides formed respectively an upper anchor portion and a lower anchor portion.

The spring has one end butting the bolt holder and another end butting the bushing.

The core is held in the core holding chamber of the bushing and has a keyway at one end and a distal end at another end that has two corresponding insertion grooves.

The press dock includes a body with an open chamber at one side to receive the bushing and an opening at another side leading to the open chamber.

The bolt has a stem with one end formed an insertion section which has an indented latch groove formed thereon.

By means of the structure set forth above, when in use for locking the trailer lock forms a double-side latching by wedging the upper and lower anchor portions in the latch groove at two sides of the bolt to generate reinforced effect, thus provides enhanced capability to withstand destruction and prevent damage by external forces.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional trailer lock.

FIG. 2 is an exploded view of the invention.

FIG. 3 is a perspective view of the invention.

FIG. 4 is a schematic view of the invention in a use condition.

FIG. 5 is a schematic view of the invention in another use condition.

FIG. 6 is a schematic view of the invention showing the U-shaped elastic element and distal end in a use condition.

FIG. 7 is a cross section taken on line I-I in FIG. 5 showing the U-shaped elastic element and distal end in a use condition.

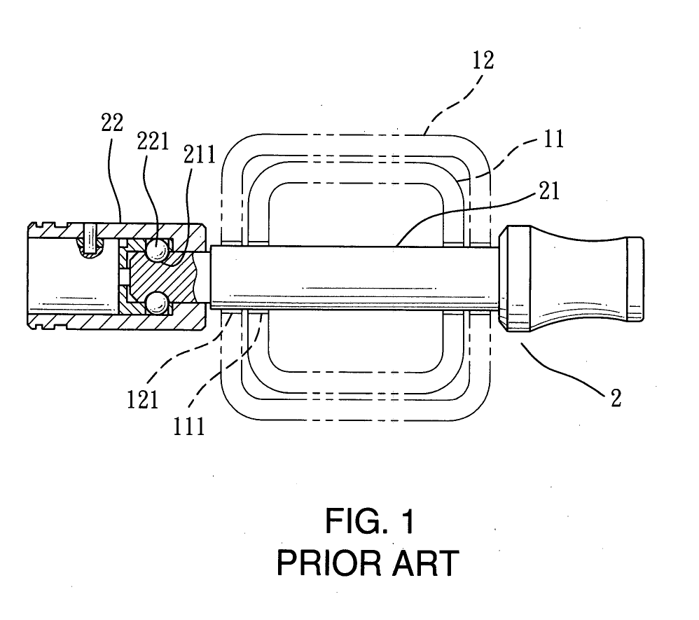

### DESCRIPTION OF THE PREFERRED EMBODIMENTS

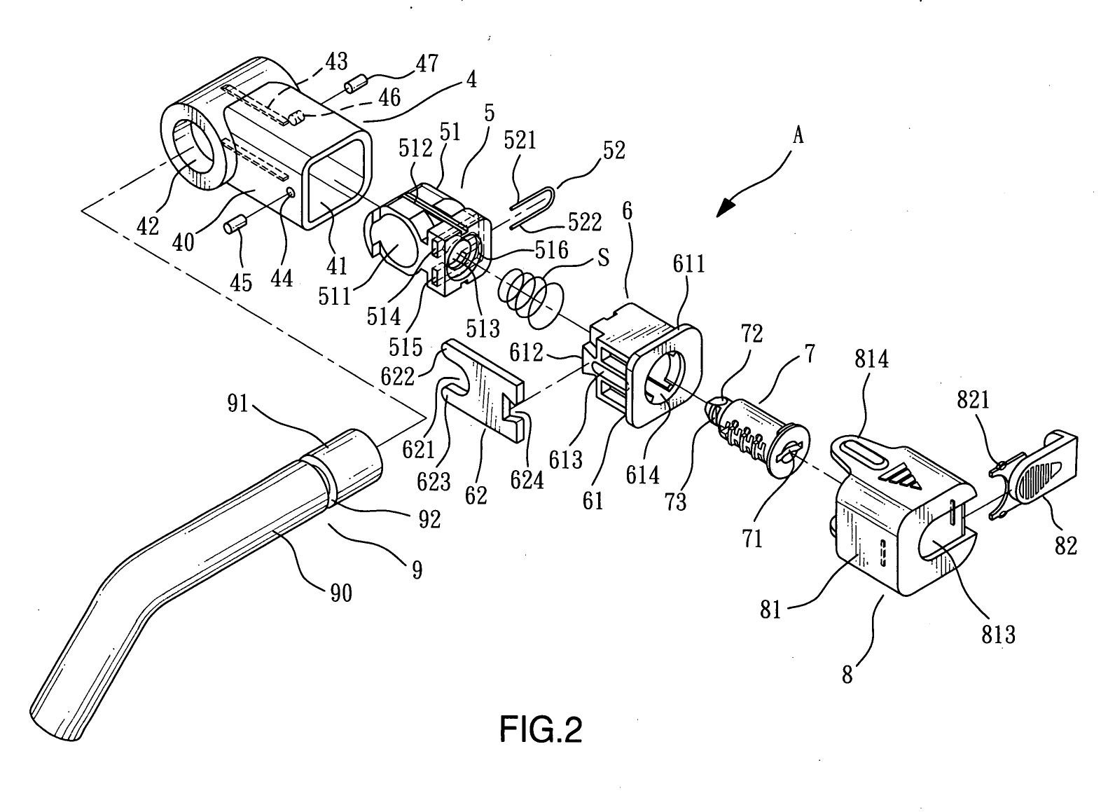

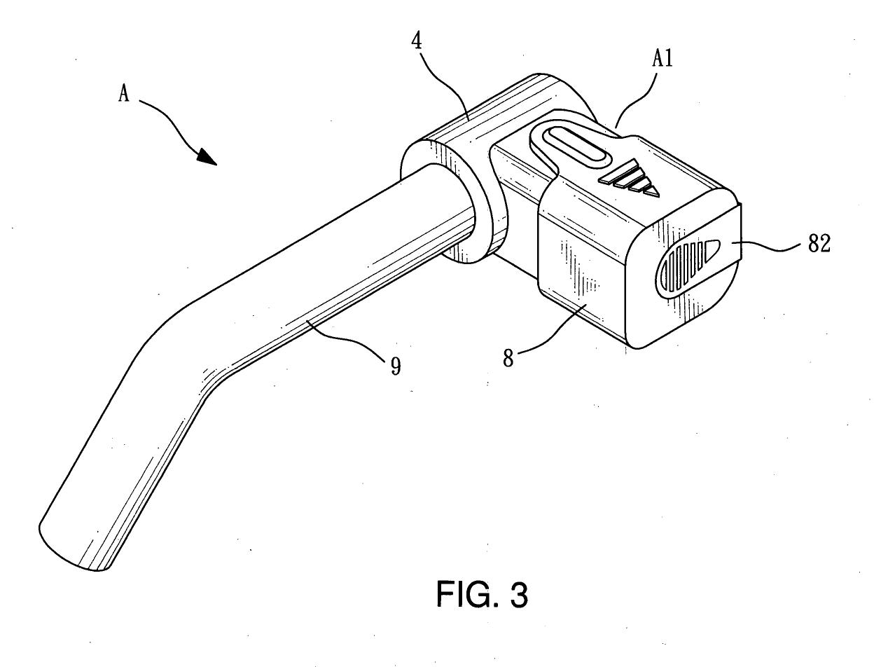

Please referring to FIGS. 2, 3 and 4, the present invention aims to provide a trailer lock A which includes a lock body A1 and a bolt 9. The lock body A1 includes at least a housing 4, a bolt holder 5, a bushing 6, a spring S, a core 7 and a press dock. 8. The lock body A1 and the bolt 9 can be coupled with coupling bores 321 and 311 formed respectively on a vehicle coupler 32 and a trailer hitch 31 to form coupling between a vehicle and a trailer and provide theft deterrent function.

The housing 4 has a first chamber 41 at one side and a second chamber 42 at another side perpendicular to the first chamber 41 and communicating therewith. The first chamber 41 has an inner wall with at least one detent rib 43 formed thereon. The housing 4 has a case 40 with a first pin hole 44 and a second pin hole 46 formed thereon to receive insertion of a first pin 45 and a second pin 47.

The bolt holder 5 is held in the first and second chambers 41 and 42, and has a body 51 with a bolt insertion hole 511 at one side and at least one detent trough 512 on a lateral side wedged in by the detent rib 43, and another side with a cavity 513 formed thereon, a stepped opening 516 at the circumference of the cavity 513, and a first insertion slot 514 and a second insertion slot 515 transversely formed on an outer side of the stepped opening 516 in a parallel manner to be wedged in by a first side section 521 and a second side section 522 of a U-shaped elastic element 52.

The bushing 6 has a barrel 61 with one side extended outwards to form an outer flange 611. The barrel 61 also has a core holding chamber 614 and a wedge member 612 and a slot 613 on the periphery. The wedge member 612 is latchable with a corresponding wedge notch 624 at one end of a latch plate 62. The latch plate 62 has another end formed a wedge trough 621 for the bolt that has two sides formed respectively an upper anchor portion 622 and a lower anchor portion 623.

The spring S has one end butting the bolt holder 5 and another end butting the bushing 6.

The core 7 is held in the core holding chamber 614 of the bushing 6. The internal structure of the core 7 is known in the art, thus details are omitted herein. The core 7 has a keyway 71 at one end and a distal end 72 at another end that has two corresponding insertion grooves 73 parallel with each other.

The press dock 8 includes a body 81 with an open chamber 810 at one side to receive the bushing 6 and two opposing lugs 814, and an opening 813 at another side leading to the open chamber 810. The open chamber 810 further has a holding groove 811 at the bottom side to be wedged in by the outer flange 611 of the bushing 6 for positioning. The opening 813 has two corresponding latch grooves 812 indented sideward on the circumference to be slidly latched by extended edges 821 on lateral sides of a dust deterrent lid 82.

The bolt 9 has a stem 90 with one end formed an insertion section 91 which has an indented latch groove 92 formed thereon.

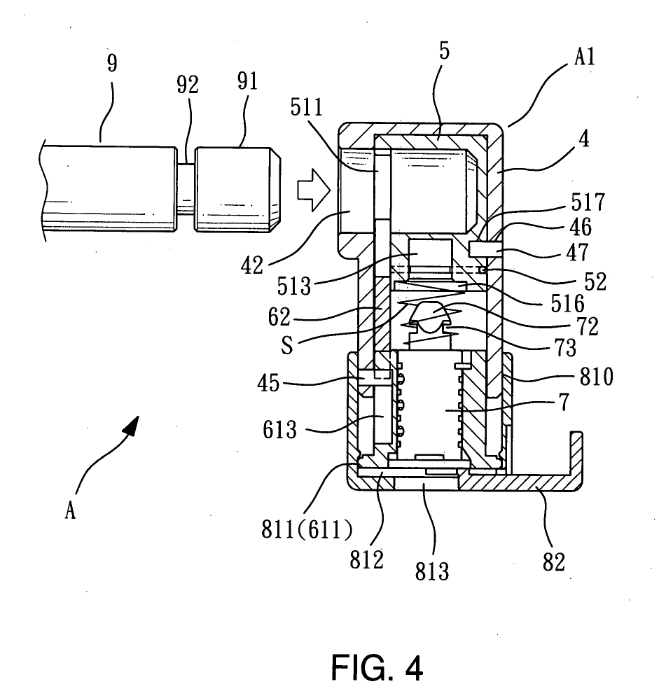

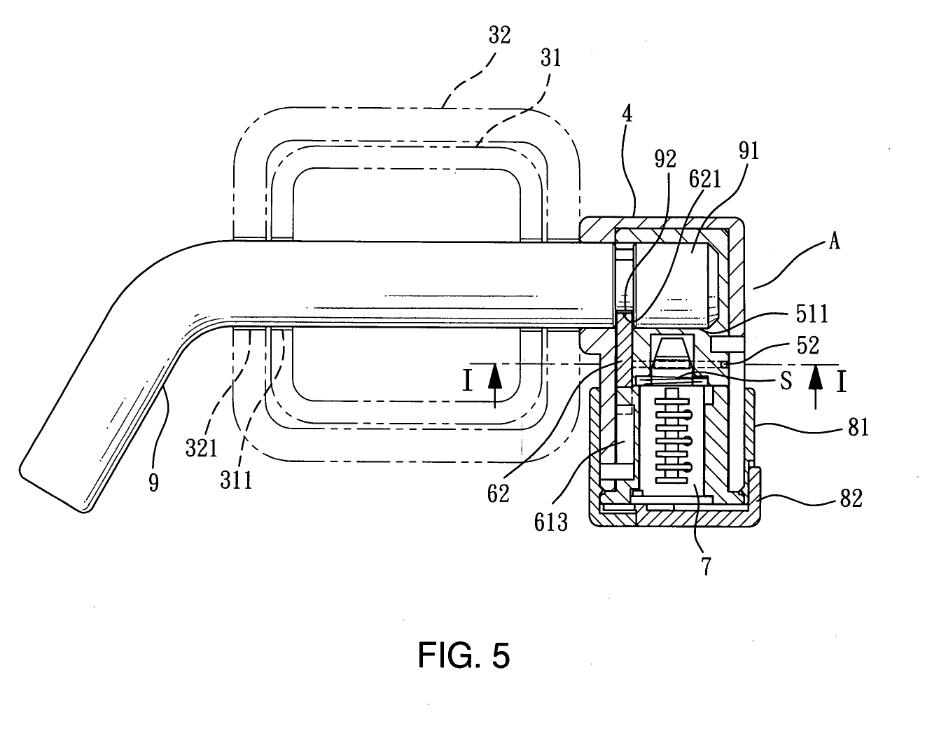

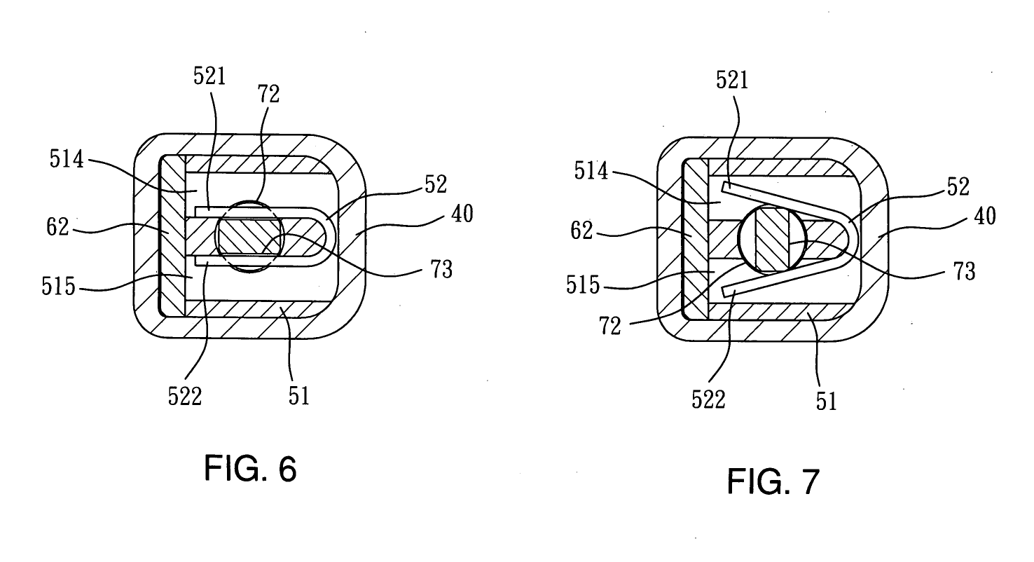

Referring to FIG. 4, when the lock body Al is in an unlocking condition and locking is desired, insert the insertion section 91 of the bolt 9 into the bolt insertion hole 511; press the press dock 8 inwards to compress the spring S to move the bushing 6; the press dock 8 is moved inwards under direction of the slot 613 and the first pin 45; the latch plate 62 is driven so that the wedge trough 621 is wedged in the latch groove 92 of the bolt 9, and latched by the upper and lower anchor portions 622 and 623 to prevent escaping of the bolt 9; meanwhile, the U-shaped elastic element 52 is expanded by the distal end 72 (referring to FIG. 7); then the core 7 can be turned to the locking position with the distal end 72 swiveled at the same time so that the first side section 521 and second side section 522 of the U-shaped elastic element 52 are moved to wedge in the insertion groove 73 (referring to FIGS. 5 and 6) to form a locking condition. When unlocking is desired, proceed the aforesaid steps reverse, first, turn the core 7 to swivel the distal end 72 to expand the U-shaped elastic element 52 and remove the first and second side sections 521 and 522 away from the insertion groove 73 (referring to FIG. 7); the spring S is free from the compression and provides a return elastic force to drive the press dock 8 outwards and move the latch plate 62 rearwards at the same time to release latching on the bolt 9; thus the bolt 9 an be removed from the bolt insertion hole 511 to accomplish unlocking.

As a conclusion, the invention employs the upper and lower anchor portions of the latch plate to form double sides and vertical latch on the bolt, thus can overcome the drawback of the conventional technique which has the core moved circularly to drive the steel ball (or cylindrical strut) to latch the bolt, and also provides a reinforced lock body to withstand destruction and theft deterrent function. It provides a significant improvement over the conventional technique.

I claim:

1. An improved trailer lock comprising a lock body and a bolt; the lock body including at least a housing, a bolt holder, a bushing, a spring, a core and a press dock, wherein
the housing includes a first chamber at one side and a second chamber at another side perpendicular to the first chamber and communicating therewith;
the bolt holder is held in the first chamber and the second chamber, and includes a bolt insertion hole at one side and a cavity at another side, a stepped opening at the circumference of the cavity, and a first insertion slot and a second insertion slot transversely formed on an outer side of the stepped opening in a parallel manner to be wedged in by a first side section and a second side section of a U-shaped elastic element;
the bushing includes a barrel which has one side extended outwards to form an outer flange, the barrel also having a core holding chamber and a wedge member and a slot on the periphery, the wedge member being latchable with a corresponding wedge notch at one end of a latch plate, the latch plate having another end formed a wedge trough for the bolt, the wedge trough having two sides formed respectively an upper anchor portion and a lower anchor portion;
the spring has one end butting the bolt holder and another end butting the bushing;
the core is held in the core holding chamber of the bushing and has a keyway at one end and a distal end at another end that has two corresponding insertion grooves;
the press dock includes a body which has an open chamber at one side to receive the bushing; and
the bolt has a stem which has one end formed an insertion section which has an indented latch groove formed thereon.

2. The improved trailer lock of claim 1, wherein the first chamber contains an inner wall which has at least one detent rib formed thereon to wedge in at least one detent trough formed on one side of the bolt holder.

3. The improved trailer lock of claim 1, wherein the press dock has two opposing lugs at one side.

4. The improved trailer lock of claim 1, wherein the open chamber of the press dock has a holding groove at the bottom side to be wedged in by the outer flange of the bushing to form positioning.

5. The improved trailer lock of claim 1, wherein the housing includes a case which has a first pin hole to receive insertion of a first pin.

6. The improved trailer lock of claim 1, wherein the housing includes a case which has a second pin hole to receive insertion of a second pin
